(19) United States
(12) Patent Application Publication
(10) Pub. No.: US 2020/0284300 A1
(43) Pub. Date: Sep. 10, 2020

(54) LOW-DRIFT OPTICAL MOUNT

(71) Applicant: Shanghai Institute of Optics And Fine Mechanics, Chinese Academy of Sciences, Shanghai (CN)

(72) Inventors: Jianqiang ZHU, Shanghai (CN); Chao ZHANG, Shanghai (CN); Gengxiu TANG, Shanghai (CN); Zhigang LIU, Shanghai (CN); Lifeng DU, Shanghai (CN)

(73) Assignee: Shanghai Institute of Optics And Fine Mechanics, Chinese Academy of Sciences

(21) Appl. No.: 16/732,246

(22) Filed: Dec. 31, 2019

(30) Foreign Application Priority Data
Mar. 4, 2019 (CN) 201910159078.0

(51) Int. Cl. F16D 1/05; G02B 7/00

(52) U.S. Cl. CPC F16D 1/05; G02B 7/003

(57) ABSTRACT

A low-drift optical mount comprising a first plate, a second plate, at least one drive rod, at least one collet. A first collet may extend through a bore of the second plate and has an inner screw matching the external screw of a first drive rod. The first drive rod may have a contact end with the first plate and a spring pulls the first plate back toward the second plate. The collet may have at least one slot that extends through the own inner thread surface. The slot can relieve the drift performance induced by grease which fills in the thread fit clearance and further improve the position stability of optical mount.

### CROSS-REFERENCE TO RELATED APPLICATION

The subject application claims priority on Chinese patent application no. 201910159078.0 filed on Mar. 4, 2019 in China. The contents and subject matter of the Chinese priority application is incorporated herein by reference.

### FIELD OF TECHNOLOGY

The present invention relates to optical mount, particularly, an optical mount with relieved position drift due to introduced grease in thread fit clearance, which is useful for fine micro tuning of the angle and position change of optical elements.

### BACKGROUND OF INVENTION

A common optical mount as shown in FIG. 1 is mainly used for precisely adjusting the angular position of the optical device 7 (such as lenses and mirrors) mounted on the first plate 1. The mount includes a first plate 1, a second plate 2, at least one drive rods 3, at least one spring 4, at least two pins 5, and at least one collet 6. A drive rod 3 threads through a collet 6 which is attached to the second plate 2. A spring 4 is opened by two pins 5 respectively inserted into the first plate 1 and the second plate 2, resulting in the first plate 1 being pulled toward the second plate 2 and pressing against the spherical end of the drive rod 3. By rotating the drive rod 3, one can precisely adjust angular position of the mount and the optical device 7. In order to ensure the smoothness of thread adjustment, grease is usually added to the thread pair. On the one hand, the grease may produce hysteresis after each adjustment, and on the other hand, it may produce slow creep under the tension of one-way springs, which is disadvantage to the angular position of the first plate and optical device relative to the second plate.

FIG. 2 shows a thread engagement diagram of the common optical mount when the spring 4 is not tensioned. The external thread surface of a drive rod 3 is fully applied with grease and then screwed into a collet 6. Before the spherical end touching the first plate 1, the drive rod 3 is not subjected to force, so the thread engagement is loose fit and the grease 10 is not pressed at this moment. FIG. 3 shows the thread engagement diagram of the common optical mount when the spring 4 has been one-way tensioned. The spherical end of the drive rod 3 is pulled against the first plate 1. The screw teeth of the drive rod 3 and the collet 6 are one-way fitted, that is, the inner thread 8 of the collet 6 is attached to the external thread 9 of the drive rod 3. Due to the axial and radial local contact of the thread fit, it is easy to form a plurality of partially enclosed small spaces. In the situation, the grease 11 on the pressure side under one-way tension force may be local blocking which produces non-rigid contact similar to piton effect. The contact makes the relative position of the drive rod 3 and the collet 6 susceptible to change in environment (such as temperature change and vibration shock), that is, drift phenomenon. It will also continually produce small position change as the grease 11 on the pressure side creeps over time which will react directly to the optical device and may have great influence in high power laser optical system.

Some manufacturers have done some measures to achieve rigid contact to improve such drift of the optical mount, such as not adding grease but selecting wear-resistant materials for precision machining, controlling gap of the thread fit and roughness of the thread surface. However these materials will also wear out for a certain period of time for lacking of grease and requirements for materials and manufacture are relatively strict and the price is relatively expensive. In view of the issues, it is necessary to improve the common optical mount to solve above problems.

### SUMMARY OF THE INVENTION

The present invention provides a low-drift optical mount that can relieve the drift performance induced by grease which fills in the thread fit clearance and further improves the position stability of the optical mount.

The low-drift optical mount of the present invention may include a first plate, a second plate, at least one drive rod, and at least one collet.

In the present invention, a drive rod has an external thread surface with an inner hexagonal slot on one side and a spherical end on the other side which engage the first plate.

In the present invention, a collet that is attached to the second plate has an external cylinder surface with a shoulder on one end. An inner screw surface of the collet is machined to match the external screw surface of the drive rod. At least one slot is uniformly distributed in the circumferential direction of the inner screw surface and extends through the entire internal thread length.

In the present invention, grease is applied to the external thread surface of the drive rod.

The drive rod is screwed into the collet after the external thread surface of the drive rod is applied enough grease. The first plate and the second plate are respectively mounted with pins on which two ends of a spring are respectively mounted pulling the first plate toward the second plate. The drive rod may have a contact end with the first plate under one-way tension of the spring.

Compared with the common optical mount, the low-drift optical mount of the present invention has beneficial effects. Because of the inner thread surface of the collet having at least one slot, a plurality of partially enclosed small spaces mentioned above will be connected with each other to form a pressure relief groove of the grease. Each time when the drive rod is turned, the grease on the pressure side under one-way tension force will be pressed into the slot to achieve close fit of the thread surface. It can improve the non-rigid contact caused by grease and improve the position stability of the optical mount. At the same time, a small amount of grease is carried into the thread surface to achieve lubrication of the screw surface.

### BRIEF DESCRIPTION OF THE DRAWINGS

FIG. 1 shows the common optical mount in the prior art.

FIG. 2 shows the thread engagement diagram of the common optical mount when the spring is not tensioned.

FIG. 3 shows the thread engagement diagram of the common optical mount when the spring has been one-way tensioned.

FIG. 4 shows an exploded view of an embodiment of the low-drift mount of the present invention.

FIG. 5 shows the specific fit structure of a drive rod and a collet of the present invention.

FIG. 6 shows the thread engagement diagram of the low-drift optical mount of the present invention when the spring has been one-way tensioned.

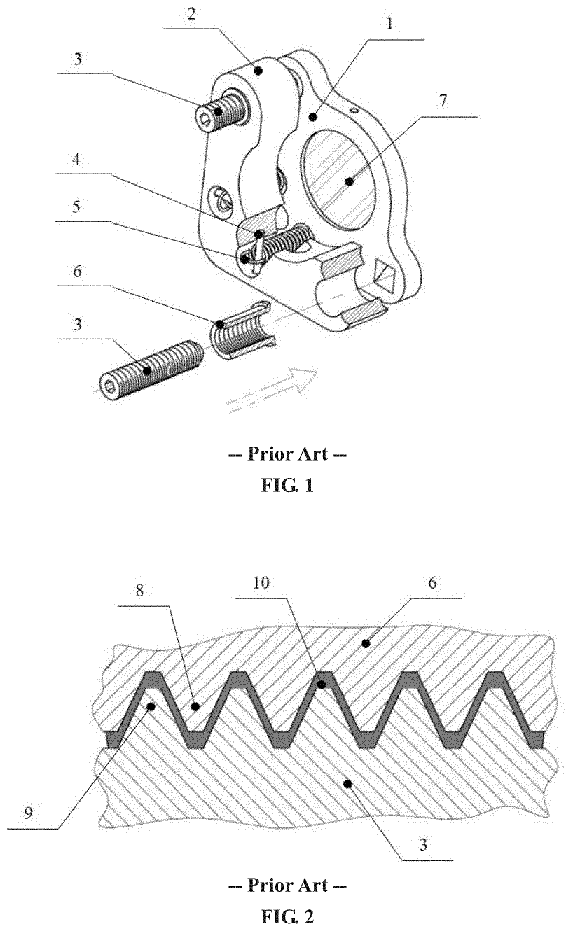

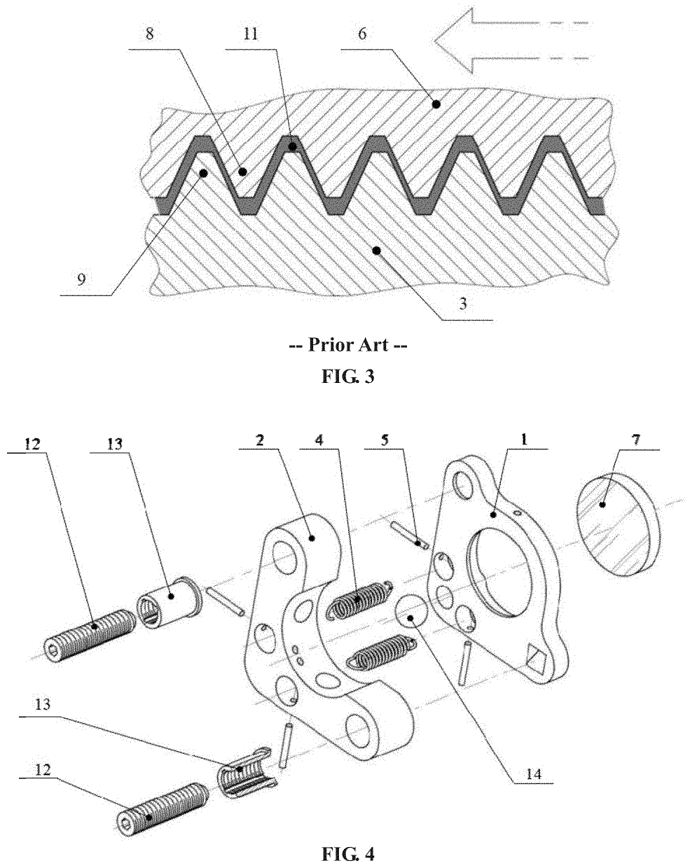

### DETAILED DESCRIPTION OF THE INVENTION

In connection with the attached figures, the present invention is further explained in details.

As shown in FIG. 4, a low-drift optical mount may include a first plate 1, a second plate 2, at least one drive rod 12, at least one collet 13, at least one spring 4, at least two pins 5 and pivot ball 14.

FIG. 5 shows the specific fit structure of a drive rod and a collet of the present invention. A drive rod 12 has an external thread surface 15 around the cylinder surface, an inner hexagonal slot 16 on one end surface and a spherical end 17 on the other end surface. The thread surface 15 is used to match the inner thread surface 20 of the collet 13. The hexagonal slot is used to adjust the position of the drive rod 12 and the spherical end 17 has a contact end with the first plate 1.

As shown in FIG. 5, the left side of the collet 13 is a cylindrical surface 18 forming a stationary fit with the corresponding hole surface of the second plate 2 and the right side is a short shoulder 19 which can achieve axial positioning of the collet 13 relative to the second plate 2. The thread surface 20 is machined to match the thread surface 15 of the drive rod 12. At least one slot 21 is evenly distributed in the circumferential direction of the inner screw thread 20 and extends through the entire internal thread length of the collet 13.

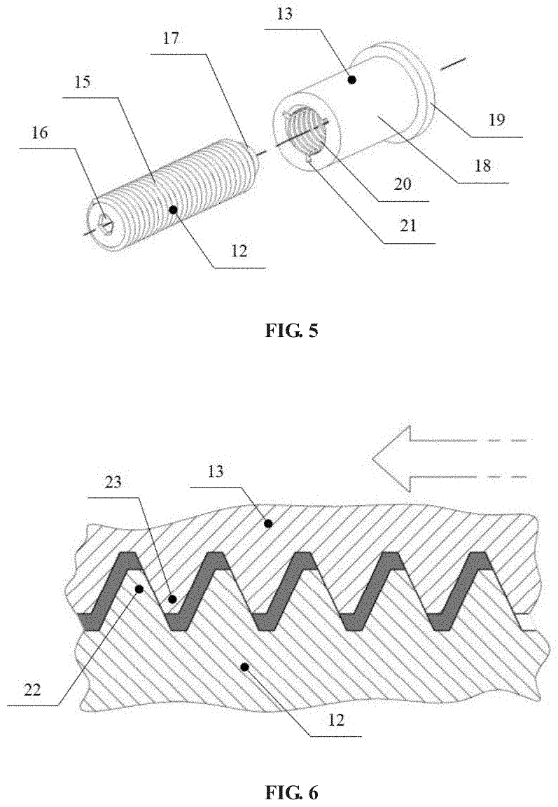

The collet 13 is first fixed to the second plate 2 by a cylindrical surface 18, and the drive rod 12 is screwed into the collet 13 until the spherical end touches the first plate 1. Before screwing into the collet 13, the external thread surface 15 of the drive rod 12 is applied enough grease. The first plate 1 and the second plate 2 are respectively mounted with pins 5 on which two ends of a spring 4 are respectively mounted pulling the first plate 1 toward the second plate 2. FIG. 6 shows the thread engagement diagram of a low-drift optical mount of the present invention when the spring 4 has been one-way tensioned. When the drive rod 12 is pulled against the first plate 1, the inner thread 23 of the collet 13 will press close to the external thread 22 of the drive rod 12 under the pre-tensioned force of the spring 4. Each time when the drive rod 12 is turned, the excess grease on the pressure side which hinders the one-way contact of the inner thread 23 and the external thread 22 is squeezed into the slot, achieving close fit of the thread surface. This can improve the non-rigid contact caused by grease, improving the position stability of the optical mount. At the same time a small amount of grease is carried into the thread surface to achieve lubrication of the screw.

The scope of the present invention is not limited by the detailed descriptions, and one of ordinary skill in the art could modify and change of the low-drift optical mount without departing from the scope of the present invention.

We claim:

1. A low-drift optical mount, comprising
a first plate,
a second plate,
a first drive rod comprising an external thread surface, the external thread surface further comprises an inner hexagonal slot on one side and a spherical tip on other side that engages the first plate;
a collet attached to the second plate, the collet comprising an external cylinder surface with a shoulder on one end and an inner screw surface matching the external screw surface of the first drive rod, the external cylinder surface further comprises at least one slot evenly distributed in a circumferential direction and extending through entire internal thread length.

2. The low-drift optical mount as recited in claim 1, wherein grease is applied to the external thread surface of the drive rod.

3. The low-drift optical mount as recited in claim 1, wherein the first plate and the second plate are respectively mounted with pins on which two ends of a spring are respectively mounted pulling the first plate toward the second plate.
